(19) United States
(12) Patent Application Publication
(10) Pub. No.: US 2025/0330787 A1
(43) Pub. Date: Oct. 23, 2025

(54) METHOD FOR INFRASTRUCTURE-SUPPORTED ASSISTANCE OF A MOTOR VEHICLE

(71) Applicant: Robert Bosch GmbH, Stuttgart (DE)

(72) Inventors: Stefan Nordbruch, Leonberg (DE); Bernd Gassmann, Aspach (DE); Jonas Guenther, Schaafheim (DE); Markus Thamm, Stuttgart (DE); Peter Sautter, Lauffen (DE); Uwe Wilbrand, Leutenbach (DE)

(21) Appl. No.: 19/181,278

(22) Filed: Apr. 16, 2025

(30) Foreign Application Priority Data
Apr. 22, 2024 (DE) 10 2024 203 733.8

(51) Int. Cl. H04W 4/44; G05D 1/225; H04L 9/06

(52) U.S. Cl. CPC H04W 4/44; G05D 1/225; H04L 9/0643

(57) ABSTRACT

A method for infrastructure-supported assistance of a motor vehicle using at least two data processing devices. The method includes: receiving, using the data processing devices, same surroundings data representing a surroundings of the motor vehicle; calculating, using the data processing devices, infrastructure assistance data for infrastructure-supported assistance of the motor vehicle based on the respective received surroundings data; comparing, using the data processing devices, the respective self-ascertained infrastructure assistance data with infrastructure assistance data ascertained by another of the at least two data processing devices to calculate a comparison result; applying, using the data processing devices, a same hash function to the respectively calculated comparison result to calculate a respective hash value; sending, using the data processing devices, the respectively calculated hash value to the motor vehicle; sending, using the data processing devices, the infrastructure assistance data ascertained using the one data processing device to the motor vehicle.

### CROSS REFERENCE

The present application claims the benefit under 35 U.S.C. § 119 of German Patent Application No. DE 10 2024 203 733.8 filed on Apr. 22, 2024, which is expressly incorporated herein by reference in its entirety.

### FIELD

The present invention relates to a method for infrastructure-supported assistance of a motor vehicle, a method for at least partially automated guidance of a motor vehicle, a system for infrastructure-supported assistance of a motor vehicle, an apparatus for at least partially automated guidance of a motor vehicle, a computer program, and a machine-readable storage medium.

### BACKGROUND INFORMATION

PCT Patent Application No. WO 2023/004184 A1 describes a method for monitoring a road.

European Patent Application No. EP 3 674 920 A1 describes a method for creating map data. PCT Patent Application No. WO 2022/081421 A1 describes a method for data transfer within an infrastructure.

### SUMMARY

An object of the present invention is to provide efficient infrastructure-supported assistance of a motor vehicle.

An object of the present invention is also to provide efficient at least partially automated guidance of a motor vehicle.

These objects may be achieved using certain features of the present invention. Advantageous example embodiments of the present invention are disclosed herein.

According to a first aspect of the present invention, a method for infrastructure-supported assistance of a motor vehicle using at least two data processing devices is provided. According to an example embodiment of the present invention, the method includes the following steps:
receiving, by means of the data processing devices, same surroundings data representing a surroundings of the motor vehicle,
calculating, by means of the data processing devices, infrastructure assistance data for infrastructure-supported assistance of the motor vehicle based on the respective received surroundings data,
comparing, by means of the data processing devices, the respective self-ascertained infrastructure assistance data with infrastructure assistance data ascertained by another of the at least two data processing devices in order to calculate a comparison result,
applying, by means of the data processing devices, a same hash function to the respectively calculated comparison result in order to calculate a respective hash value,
sending, by means of the data processing devices, the respectively calculated hash value to the motor vehicle,
sending, by means of one of the data processing devices, the infrastructure assistance data ascertained by means of the one data processing device to the motor vehicle.

According to a second aspect of the present invention, a method for at least partially automated guidance of a motor vehicle is provided. According to an example embodiment of the present invention, the method includes the following steps:
receiving a respective hash value from at least two data processing devices,
receiving infrastructure assistance data from one of the data processing devices,
determining that the received infrastructure assistance data can be used for at least partially automated guidance of the motor vehicle based on the received hash values.

According to a third aspect of the present invention, a system for infrastructure-supported assistance of a motor vehicle is provided. According to an example embodiment of the present invention, the system includes:
at least two data processing devices which are each configured to receive same surroundings data representing a surroundings of the motor vehicle,
wherein the data processing devices are each configured to calculate infrastructure assistance data for infrastructure-supported assistance of the motor vehicle based on the respective received surroundings data,
wherein the data processing devices are each configured to compare the respective self-ascertained infrastructure assistance data with infrastructure assistance data ascertained by another of the at least two data processing devices in order to calculate a comparison result,
wherein the data processing devices are each configured to apply a same hash function to the respectively calculated comparison result in order to calculate a respective hash value,
wherein the data processing devices are each configured to send the respectively calculated hash value to the motor vehicle,
wherein one of the data processing devices is configured to send its self-ascertained infrastructure assistance data to the motor vehicle.

According to a fourth aspect of the present invention, an apparatus for at least partially automated guidance of a motor vehicle is provided. According to an example embodiment of the present invention, the apparatus includes:
a communication device configured to receive a respective hash value from at least two data processing devices and infrastructure assistance data from one of the data processing devices,
a processor device configured to determine that the received infrastructure assistance data can be used for at least partially automated guidance of the motor vehicle based on the received hash values.

According to a fifth aspect of the present invention, a computer program is provided, which comprises instructions that, when the computer program is executed by a computer, for example by the system according to the third aspect and/or by the apparatus according to the fourth aspect, cause said computer to carry out a method according to the first aspect and/or according to the second aspect.

According to a sixth aspect of the present invention, a machine-readable storage medium is provided, on which the computer program according to the fifth aspect is stored.

The present invention is based on and includes the insight that at least two data processing devices, for example three data processing devices, are used for infrastructure-supported assistance of a motor vehicle. The data processing devices are provided with the same surroundings data, wherein these surroundings data represent a surroundings of the motor vehicle. Based on these same surroundings data, each one of the data processing devices calculates infrastructure assistance data for infrastructure-supported assistance of the motor vehicle. For example, it is provided that the data processing devices send at least some of their respective ascertained infrastructure assistance data to one another, so that each data processing device compares its self-ascertained infrastructure assistance data with infrastructure assistance data ascertained by another of the at least two data processing devices. The infrastructure assistance data sent to the respective data processing devices are received by the respective data processing devices. This, for example, produces the technical advantage that the data processing devices can compare its self-ascertained infrastructure assistance data with the infrastructure assistance data ascertained by the other data processing device or the other data processing devices.

According to an example embodiment of the present invention, if there are three data processing devices, it is thus, for example, provided that the first data processing device sends its self-ascertained infrastructure assistance data to the second and to the third data processing device, and that the second data processing device does not send its self-ascertained infrastructure assistance data to the first or the third data processing device, and that the third data processing device sends its self-ascertained infrastructure assistance data to the first data processing device. The first data processing device can then compare its self-ascertained infrastructure assistance data with the infrastructure assistance data ascertained by the third data processing device and the second data processing device can compare its self-ascertained infrastructure assistance data with the infrastructure assistance data ascertained by the first data processing device and the third data processing device can compare its self-ascertained infrastructure assistance data with the infrastructure assistance data ascertained by the first data processing device.

The three data processing devices are thus in particular each configured to send at least some of their respective ascertained infrastructure assistance data to one another, so that each data processing device can compare its self-ascertained infrastructure assistance data with infrastructure assistance data ascertained by another of the at least two data processing devices.

According to an example embodiment of the present invention, it is further provided that a same hash function is applied to the respectively calculated comparison result by means of the data processing devices in order to calculate a respective hash value. The hash values calculated by the data processing devices are sent to the motor vehicle. It is further provided that one of the data processing devices, in particular only one of the data processing devices, sends its self-ascertained infrastructure assistance data to the motor vehicle.

On the motor vehicle side, these infrastructure assistance data are received by one of the data processing devices. The calculated hash values are received on the motor vehicle side as well.

According to an example embodiment of the present invention, if the data processing devices have ascertained the same infrastructure assistance data based on the same surroundings data, all of the data processing devices should also calculate or ascertain the same comparison result, so that the same hash value is accordingly calculated by each of the data processing devices.

Thus, if the data processing devices have all ascertained the same infrastructure assistance data based on the same surroundings data, the hash values received by the motor vehicle should match as well. If the hash values do not match, for example because one of the hash values differs from the other hash values, it can be assumed on the motor vehicle side that at least one of the ascertained infrastructure assistance data differs from the other infrastructure assistance data. It can therefore be determined, for example, that the received infrastructure assistance data cannot be used for at least partially automated guidance of the motor vehicle.

The reason for this is that at least partially automated guidance of a motor vehicle places high demands on the reliability and integrity of the data to be used for at least partially automated guidance of the motor vehicle. In the present case, these data are the infrastructure assistance data.

Infrastructure assistance data include an object list of objects in the vicinity of the motor vehicle, for instance. If one of the data processing devices has detected an object that has not been detected by the other data processing devices, for example, the correspondingly calculated object lists will differ from one another.

On the motor vehicle side, it is now impossible to determine which of the object lists is correct. In such a case, it is provided for safety reasons that the motor vehicle does not use any of the object lists for at least partially automated guidance of the motor vehicle, for instance. If the hash values differ from one another, it can, for example, be provided that the motor vehicle is driven with a limited at least partially automated driving function compared to the case in accordance with which all the hash values match. In other words, the motor vehicle can be driven at a lower speed when the hash values do not match than when the hash values do match, for example. If the hash values do not match, the motor vehicle may not allow at least partially automated guidance in a specific driving situation, for instance. If the hash values do not match, only a specific maximum level of automation can be permitted on the part of the motor vehicle, for instance. If the hash values do not match, only partially automated guidance can be permitted, for example, whereas if the hash values match, highly automated guidance or fully automated guidance or autonomous guidance of the motor vehicle is permitted.

This therefore in particular produces the technical advantage the motor vehicle can be driven safely in at least partially automated mode. The infrastructure can thus assist the motor vehicle efficiently; the infrastructure can in particular assist the motor vehicle safely. In other words, the infrastructure can help or assist the motor vehicle so that it can drive safely in at least partially automated mode based on the infrastructure assistance data.

This makes it possible to reduce the risk of an accident or a collision for the motor vehicle, for example. It also makes it possible to increase safety for road users in the vicinity of the motor vehicle.

Infrastructure-supported assistance of the motor vehicle means in particular that infrastructure assistance data are made available to the motor vehicle. The motor vehicle can derive instructions based on the infrastructure assistance data, for instance. For example, the motor vehicle can decide for itself what to do based on the infrastructure assistance data.

According to an example embodiment of the present invention, infrastructure assistance data include one or more of the following data elements, for example: control command for at least partially automated control of a lateral and/or longitudinal guidance of the motor vehicle, remote control command for at least partially automated remote control of a lateral and/or longitudinal guidance of the motor vehicle, enable command for enabling at least partially automated, in particular fully automated, travel of the motor vehicle for a specific period of time within a specific road section, target trajectory for the motor vehicle, target position for the motor vehicle, surroundings data that represent a surroundings of the motor vehicle, specification of what the motor vehicle should do, wherein the specification specifies whether the motor vehicle is permitted to drive or must stop, for example, object list of objects in the vicinity of the motor vehicle, information about objects in the vicinity of the motor vehicle, wherein the information includes the following, for example: speed, location, direction of travel.

Assisted guidance corresponds to level of automation 1 as defined by the German Federal Highway Research Institute (BASt). Partially automated guidance corresponds to level of automation 2 as defined by the BASt. Highly automated guidance corresponds to level of automation 3 as defined by the BASt. Fully automated guidance corresponds to level of automation 4 as defined by the BASt. Autonomous guidance corresponds to level of automation 5according to SAE (J3016), wherein SAE stands for “Society of Automotive Engineers”.

The phrase “at least partially automated guidance” includes one or more of the following cases: assisted guidance, partially automated guidance, highly automated guidance, fully automated guidance. The phrase “at least partially automated” therefore includes one or more of the following phrases: assisted, partially automated, highly automated, fully automated. At least partially automated guidance of the motor vehicle includes at least partially automated control of a lateral and/or longitudinal guidance of the motor vehicle.

Assisted guidance means that a driver of the motor vehicle continuously carries out either the lateral guidance or the longitudinal guidance of the motor vehicle. The respective other driving task (i.e. controlling the longitudinal or lateral guidance of the motor vehicle) is carried out automatically. This means that either the lateral or the longitudinal guidance is controlled automatically when the motor vehicle is guided in an assisted manner.

Partially automated guidance means that in a specific situation (for example: driving on a freeway, driving in a parking lot, passing an object, driving within a travel lane defined by lane markings) and/or for a certain period of time, a longitudinal and a lateral guidance of the motor vehicle are controlled automatically. A driver of the motor vehicle does not have to control the longitudinal and lateral guidance of the motor vehicle manually. However, the driver has to continually monitor the automatic control of the longitudinal and lateral guidance in order to be able to intervene manually when necessary. The driver has to be ready to take over complete control of the motor vehicle at all times.

Highly automated guidance means that for a certain period of time in a specific situation (for example: driving on a freeway, driving in a parking lot, passing an object, driving within a travel lane defined by lane markings) a longitudinal and a lateral guidance of the motor vehicle are controlled automatically. A driver of the motor vehicle does not have to control the longitudinal and lateral guidance of the motor vehicle manually. The driver does not have to continuously monitor the automatic control of the longitudinal and lateral guidance in order to be able to intervene manually when necessary. If necessary, a take-over request to the driver to take over control of the longitudinal and lateral guidance is issued automatically, in particular issued with adequate time to respond. The driver therefore has to potentially be able to take control of the longitudinal and lateral guidance. Limits of the automatic control of the lateral and longitudinal guidance are recognized automatically. In highly automated guidance, it is not possible to automatically bring about a minimal risk state in every initial situation.

Fully automated guidance means that, in a specific situation (for example: driving on a freeway, driving in a parking lot, passing an object, driving within a travel lane defined by lane markings), longitudinal guidance and lateral guidance of the motor vehicle are controlled automatically. A driver of the motor vehicle does not have to control the longitudinal and lateral guidance of the motor vehicle manually. The driver does not have to monitor the automatic control of the longitudinal and lateral guidance in order to be able to intervene manually when necessary. Before the automatic control of the lateral and longitudinal guidance is ended, the driver is automatically prompted to take over the driving task (control of the lateral and longitudinal guidance of the motor vehicle), in particular with adequate time to respond. If the driver does not take over the driving task, the system automatically returns to a minimal risk state. Limits of the automatic control of the lateral and longitudinal guidance are recognized automatically. In all situations, it is possible to automatically return to a minimal risk system state.

Autonomous guidance or driving means that the longitudinal and lateral guidance of the motor vehicle are automatically controlled in all situations, not just in one or more specific situations. The driver is no longer needed as a fallback level. The motor vehicle can therefore drive without a driver.

The terms “assist” and “support” can be used interchangeably.

The abbreviation “at least one” means “one or more”.

The motor vehicle is configured to be guided in an at least partially automated manner, for example.

In one embodiment of the method according to the first aspect, it is provided that the data processing devices are each implemented in a separate availability zone.

This, for example, produces the technical advantage that the data processing devices are implemented efficiently.

An availability zone is also referred to in English as an “availability zone”.

In one example embodiment of the method according to the first aspect of the present invention, it is provided that at least three data processing devices are used.

This, for example, produces the technical advantage that a particularly suitable number of data processing devices can be used.

For example, exactly three data processing devices are used.

In one example embodiment of the method of the present invention, it is provided that the at least third data processing device is implemented in the availability zone of one of the two data processing devices and is hardware-independent of said one of the two data processing devices or is implemented in a separate availability zone.

This, for example, produces the technical advantage that the at least third data processing device can be implemented efficiently.

In the case of two data processing devices, it is thus provided that each of the data processing devices is implemented in a separate availability zone, for example.

In the case of two data processing devices, it is provided that one of the data processing devices is implemented in the availability zone of the other data processing device, for instance, but is implemented independently of the other of the two data processing devices in terms of hardware.

In one example embodiment of the method according to the first aspect of the present invention, it is provided that the respective calculation of the infrastructure assistance data is carried out using dissimilar binary code respectively created from the same source code.

This, for example, produces the technical advantage that the infrastructure assistance data can be calculated efficiently.

According to this example embodiment, it is therefore provided that the binary code used by the data processing devices to ascertain the infrastructure assistance data is at least partially dissimilar in each case; i.e. at least one or more of the binary codes differ from one another. However, the source code, based on which the binary code used by the data processing devices was created, is the same. In other words, a same source code, based on which binary code used by the data processing devices to ascertain the infrastructure assistance data is created, is provided or used, wherein at least one, in particular several or all of the data processing devices, uses a binary code that is dissimilar compared to the other binary codes. Such dissimilar binary code can be created by one or more specific compiler settings of a compiler by means of which the binary code is compiled from the same source code, for instance.

This creates heterogeneity in terms of the binary code used by the data processing devices to ascertain the infrastructure assistance data, which is particularly advantageous from a safety-technical point of view.

In one example embodiment of the method according to the first aspect of the present invention, it is provided that a respective configuration of the data processing devices is described by one or more configuration parameters, wherein the data processing devices differ from one another in at least one of their configuration parameters.

This, for example, produces the technical advantage that it achieves diversity with respect to the data processing devices, which is particularly advantageous from a safety-technical point of view, because it makes it possible to detect systematic errors in one of the configurations of the data processing devices, for example, given that systematic errors can lead to different infrastructure assistance data being ascertained. In other words, a systematic error in a specific configuration could always lead to an incorrect result, which in turn leads to a hash value that differs from the hash values of the data processing devices that, due to a different configuration, do not exhibit this systematic error. The hash values are different then, so that the motor vehicle can react accordingly as described above. In other words, despite the presence of a systematic error in at least one of the data processing devices, a minimum level of safety for the at least partially automated guidance of the motor vehicle can be achieved.

In one example embodiment of the method according to the first aspect of the present invention, it is provided that the one or more configuration parameters are respectively selected from the following group of configuration parameters: semiconductor mask set ID of a hardware component of the data processing device, generation of a hardware component of the data processing device, manufacturer of a hardware component of the data processing device, core count of a virtual machine implemented in the data processing device, memory size, in particular memory size of a virtual machine implemented in the data processing device, type of a virtual machine implemented in the data processing device, a configuration of an operating system running in the data processing device, type of an operating system running in the data processing device, kernel version of an operating system running in the cloud infrastructure data processing device.

This, for example, produces the technical advantage that particularly suitable configuration parameters can be used.

In one example embodiment of the method according to the second aspect of the present invention, it is provided that it is determined that the received infrastructure assistance data can be used for at least partially automated guidance of the motor vehicle if the hash values match.

This, for example, produces the technical advantage that a particularly high level of safety is achieved with respect to the at least partially automated guidance of the motor vehicle.

In one example embodiment of the method according to the second aspect of the present invention, it is provided that said determination is carried out by a watchdog.

This, for example, produces the technical advantage that the determination can be carried out efficiently. This moreover produces the technical advantage that the determination, which is a safety-critical step, is carried out by a device that is trustworthy from a safety-technical point of view, the watchdog.

Features of the method according to the first aspect of the present invention emerge analogously from features of the system according to the third aspect of the present invention and vice versa. Statements made in connection with the system according to the third aspect apply analogously to the method according to the first aspect and vice versa.

Features of the method according to the second aspect of the present invention emerge analogously from features of the apparatus according to the fourth aspect of the present invention and vice versa. The statements made for the method according to the second aspect apply analogously to the apparatus according to the fourth aspect and vice versa.

The method according to the second aspect comprises at least partially automated guidance of the motor vehicle based on the received infrastructure assistance data, for example.

Statements made in connection with the method according to the first aspect of the present invention apply analogously to the method according to the second aspect of the present invention and vice versa.

The hash values received according to the method according to the second aspect of the present invention are the hash values calculated as part of the method according to the first aspect, for instance.

For example, it is provided that features of the method according to the first aspect of the present invention and features of the method according to the second aspect of the present invention are realized or provided in a common embodiment. This means that the method according to the first aspect and the method according to the second aspect are carried out in a common embodiment, for example.

The method according to the first aspect of the present invention is a computer-implemented method, for instance.

The method according to the second aspect of the present invention is a computer-implemented method, for instance.

The system according to the third aspect of the present invention is, for example, programmed to execute the computer program.

The apparatus according to the fourth aspect of the present invention is, for example, programmed to execute the computer program.

The method according to the first aspect of the present invention is carried out by means of the system according to the third aspect of the present invention, for example.

The method according to the second aspect of the present invention is carried out by means of the apparatus according to the fourth aspect of the present invention, for example.

A motor vehicle is provided, for instance, which comprises the apparatus according to the fourth aspect.

A data processing device within the meaning of the description is implemented in a cloud infrastructure, for example.

Statements made in connection with a data processing device apply analogously to a plurality of data processing devices and vice versa.

The embodiments and embodiment examples described here can be combined with one another in any manner, even if this is not explicitly stated.

The present invention is explained in more detail in the following with reference to preferred embodiment examples.

### BRIEF DESCRIPTION OF THE DRAWINGS

FIG. 1 shows a flow chart of a method according to the first aspect of the present invention.

FIG. 2 shows a flow chart of a method according to the second aspect of the present invention.

FIG. 3 shows a system according to the third aspect of the present invention.

FIG. 4 shows an apparatus according to the fourth aspect of the present invention.

FIG. 5 shows a machine-readable storage medium according to the sixth aspect of the present invention.

FIG. 6 shows a first block diagram according to an example embodiment of the present invention.

FIG. 7 shows a second block diagram according to an example embodiment of the present invention.

In the following, the same reference signs can be used for the same features.

### DETAILED DESCRIPTION OF EXAMPLE EMBODIMENTS

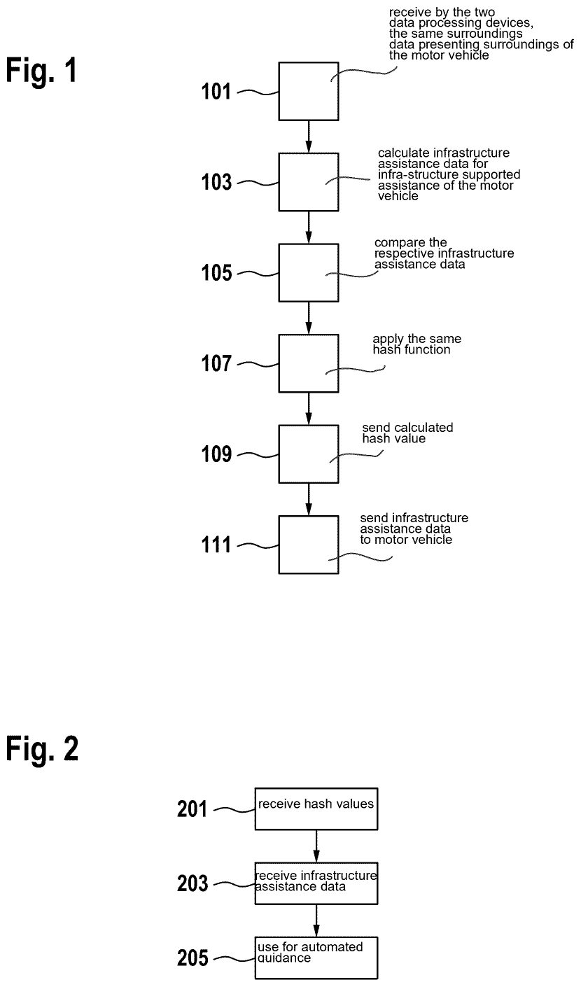

FIG. 1 shows a flow chart of a method for infrastructure-supported assistance of a motor vehicle using at least two data processing devices, comprising the following steps:
receiving 101, by means of the data processing devices, same surroundings data representing a surroundings of the motor vehicle,
calculating 103, by means of the data processing devices, infrastructure assistance data for infrastructure-supported assistance of the motor vehicle based on the respective received surroundings data,
comparing 105, by means of the data processing devices, the respective self-ascertained infrastructure assistance data with infrastructure assistance data ascertained by another of the at least two data processing devices in order to calculate a comparison result,
applying 107, by means of the data processing devices, a same hash function to the respectively calculated comparison result in order to calculate a respective hash value,
sending 109, by means of the data processing devices, the respectively calculated hash value to the motor vehicle,
sending 111, by means of one of the data processing devices, the infrastructure assistance data ascertained by means of the one data processing device to the motor vehicle.

FIG. 2 shows a flow chart of a method for at least partially automated guidance of a motor vehicle, comprising the following steps:
receiving 201 a respective hash value from at least two data processing devices,
receiving 201 infrastructure assistance data from one of the data processing devices,
determining 205 that the received infrastructure assistance data can be used for at least partially automated guidance of the motor vehicle based on the received hash values.

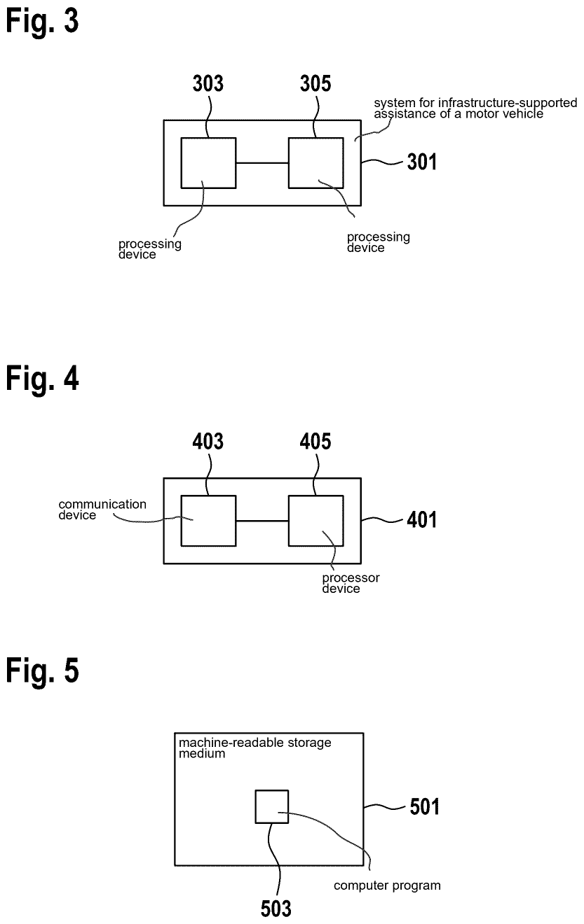

FIG. 3 shows a system 301 for infrastructure-supported assistance of a motor vehicle, comprising:
at least two data processing devices 303, 305 which are each configured to receive same surroundings data representing a surroundings of the motor vehicle,
wherein the data processing devices 303, 305 are each configured to calculate infrastructure assistance data for infrastructure-supported assistance of the motor vehicle based on the respective received surroundings data,
wherein the data processing devices 303, 305 are each configured to compare the respective self-ascertained infrastructure assistance data with infrastructure assistance data ascertained by another of the at least two data processing devices in order to calculate a comparison result,
wherein the data processing devices 303, 305 are each configured to apply a same hash function to the respectively calculated comparison result in order to calculate a respective hash value, wherein the data processing devices 303, 305 are each configured to send the respectively calculated hash value to the motor vehicle,
wherein one of the data processing devices 303, 305 is configured to send its self-ascertained infrastructure assistance data to the motor vehicle.

FIG. 4 shows an apparatus 401 for at least partially automated guidance of a motor vehicle, comprising:
a communication device 403 configured to receive a respective hash value from at least two data processing devices and infrastructure assistance data from one of the data processing devices,
a processor device 405 configured to determine that the received infrastructure assistance data can be used for at least partially automated guidance of the motor vehicle based on the received hash values.

Sending and/or receiving within the meaning of the description includes sending and/or receiving via one or more communication networks, for instance, for example the Internet. A communication network is a wired communication network, for example an Ethernet network, or a wireless communication network, for example a cellular network or Wi-Fi network.

FIG. 5 shows a machine-readable storage medium 501 on which a computer program 503 is stored. The computer program 503 comprises instructions that, when the computer program 503 is executed by a computer, cause said computer to carry out a method according to the first aspect and/or according to the second aspect.

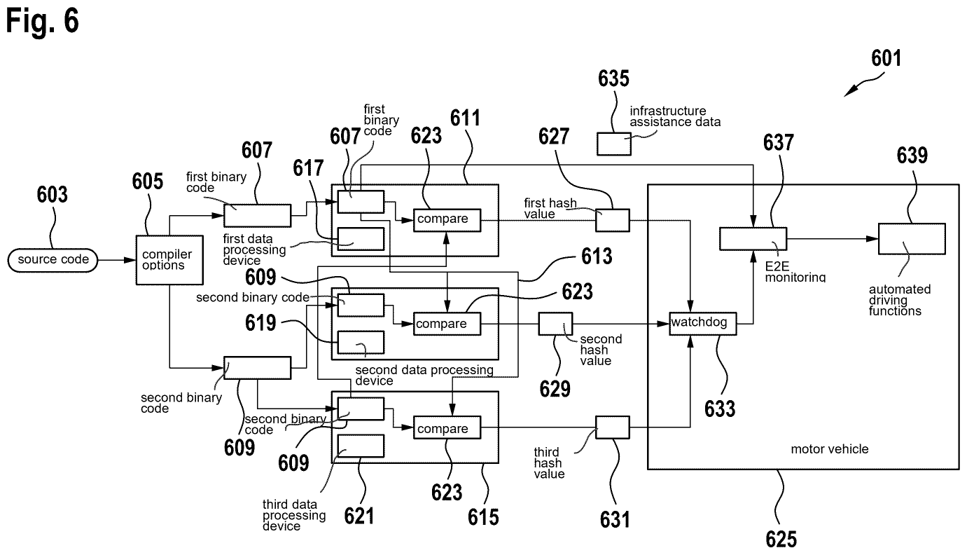

FIG. 6 shows a first block diagram 601 that explains the here-described concept using an example.

A first binary code 607 and a second binary code 609 are created from a source code 603 using various compiler options 605. The two binary codes 607, 609 are therefore different, i.e. dissimilar.

A first availability zone 611, a second availability zone 613 and a third availability zone 615 are provided as well.

A data processing device is implemented in each of the three availability zones 611, 613, 615. A first data processing device 617 is implemented in the first availability zone 611. A second data processing device 619 is implemented in the second availability zone 613. A third data processing device is implemented in the third availability zone 615.

For example, it is provided that the third data processing device 621 is not implemented in a separate availability zone, but rather in one of the two availability zones 611, 613; i.e. for example in the first availability zone 611 or in the second availability zone 613. In that case, the third data processing device 621 is hardware-independent of the data processing device of the corresponding availability zone.

The first data processing device 617 uses the first binary code 607 to ascertain infrastructure assistance data based on surroundings data representing a surroundings of a motor vehicle.

The second data processing device 619 uses the second binary code 609 to ascertain infrastructure assistance data for the motor vehicle based on the same surroundings data as the first data processing device 617.

The third data processing device 621 uses the second binary code 609 to ascertain infrastructure assistance data for the motor vehicle based on the same surroundings data as the first and the second data processing devices 617, 619.

The first data processing device 617 sends its self-ascertained infrastructure assistance data to the second data processing device 619 and to the third data processing device 621.

The second data processing device 619 does not send its self-ascertained infrastructure assistance data to the first data processing device 617 or the third data processing device 621.

The third data processing device 621 sends its self-ascertained infrastructure assistance data to the first data processing device 617.

The infrastructure assistance data sent to the respective data processing devices are received by the respective data processing devices.

The first data processing device 617 compares its self-ascertained infrastructure assistance data with the infrastructure assistance data ascertained by the third data processing device 621.

The second data processing device 619 compares its self-ascertained infrastructure assistance data with the infrastructure assistance data ascertained by the first data processing device 617.

The third data processing device 621 compares its self-ascertained infrastructure assistance data with the infrastructure assistance data ascertained by the first data processing device 617.

This comparison is symbolically represented by a function block 623.

A comparison result is therefore calculated on the basis of the comparison. Each of the three data processing devices 617, 619, 621 then applies a same hash function to the comparison result in order to calculate a hash value. The calculated hash values are then sent to a motor vehicle 625.

Specifically, the first data processing device 617 thus sends a first hash value 627 to the motor vehicle 625.

The second data processing device 619 sends a second hash value 629 to the motor vehicle 625.

The third data processing device 621 sends a third hash value 631 to the motor vehicle 625.

The three hash values 627, 629, 631 are thus received on the motor vehicle side and compared with one another by a watchdog 633.

It is further provided that one of the data processing devices 617, 619, 621 sends its self-ascertained infrastructure assistance data to the motor vehicle 625. In FIG. 6, for example, it is the first data processing device 617 that sends the infrastructure assistance data 635 to the motor vehicle 625. For example, it can be provided that the second and/or third data processing device 619, 621 send the respectively ascertained infrastructure assistance data to the motor vehicle 625 as well or instead.

Based on the comparison of the received hash values 627, 629, 631, the watchdog 633 determines whether or not the received infrastructure assistance data 635 can be used for at least partially automated guidance of the motor vehicle 625.

According to a function block 637, so-called “E2E monitoring” is carried out. “E2E” is “end-to-end”. Monitoring is monitoring. “E2E monitoring” therefore stands for “end-to-end monitoring”.

E2E-Monitoring is used in particular to
1. check the correct transmission of the received infrastructure assistance data 635 from the respective data processing devices to the motor vehicle 625, and/or,
2. if the watchdog 633 returns an “OK” (because all hash values match), forward the received and checked infrastructure assistance data 635 to the motor vehicle control system for final implementation.

The received infrastructure assistance data 635 can thus, for instance, be used for one or more at least partially automated driving functions 639 of the motor vehicle 625.

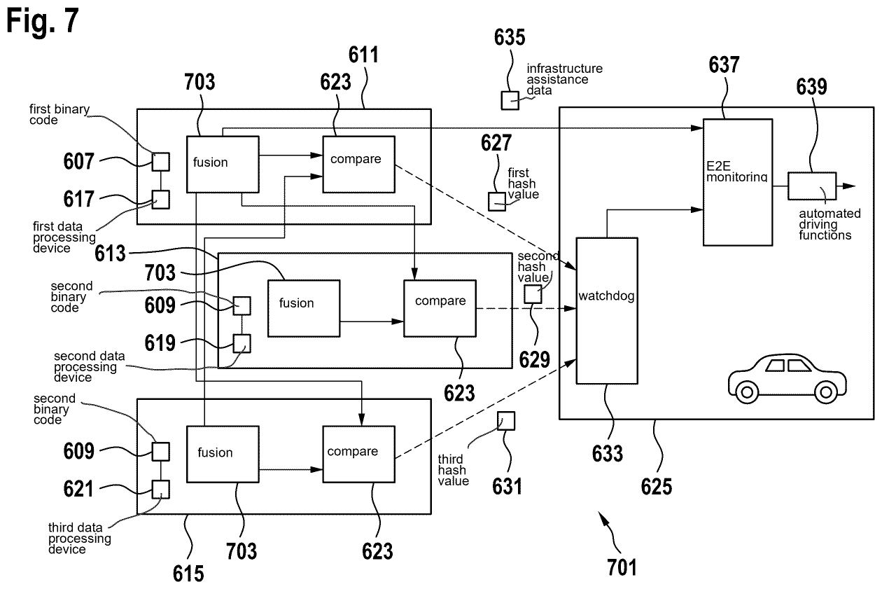

FIG. 7 shows a second block diagram 701 that explains the here-described concept using an example.

The second block diagram 701 is based on the first block diagram 601 of FIG. 6.

As an example for ascertaining infrastructure assistance data, it is provided that the data processing devices 617, 619, 621 each carry out a fusion of the received surroundings data according to a functional block 703. This is provided, for instance, if the surroundings data include surroundings sensor data from a plurality of surroundings sensors that have acquired a surroundings of the motor vehicle. Video data can be fused with radar data and/or LiDAR data, for example.

For example, an object list with objects in the vicinity of the motor vehicle can be ascertained by means of the data processing devices 617, 619, 621 based on the fusion. This object list is thus an example of infrastructure assistance data within the meaning of the description. This object list can then be sent to the motor vehicle 625, for example by the first data processing device 617, and, on the motor vehicle side, the watchdog 633 determines whether or not it can be used for at least partially automated guidance of the motor vehicle 625. This determination is carried out in accordance with the explanations given in the description based on a comparison of the three hash values 627, 629 and 631.

In summary, the here-described concepts are based on the fact that data, in the present case infrastructure assistance data which originate from an infrastructure, in this case the data processing devices which are, for instance, implemented in a cloud infrastructure, can be checked in the motor vehicle for reliability and, if the check is positive, also used for at least partially automated guidance of the motor vehicle. It is in particular provided that the calculation or the ascertainment of the infrastructure assistance data is carried out redundantly. This is achieved by using at least two data processing devices, in particular three.

For example, it is provided that at least partially different binary code created from a same source code is used to calculate the infrastructure assistance data.

It is further provided that the data processing devices have at least partially different configurations, for instance.

The respectively ascertained infrastructure assistance data are cross-compared by the data processing devices, wherein a respective comparison result is the basis for a hash calculation. In other words, a same hash function is applied to the specifically ascertained comparison result by means of the data processing devices in order to calculate a hash value each. These hash values are sent to the motor vehicle.

The hash function is a checksum, for example.

The motor vehicle in particular includes ASIL-qualified hardware on which incoming hash values can be compared. If they are identical, the infrastructure assistance data received by the motor vehicle, in particular in parallel with the hash values, can be safely used for at least partially automated guidance, i.e. for an at least partially automated driving function.

The abbreviation “ASIL” stands for “Automotive Safety Integrity Level,” which can be translated into German as “automotive Sicherheitsintegritätslevel”. The Automotive Safety Integrity Level is a key component of the ISO 26262 standard. ASIL distinguishes between four different ASIL risk levels which are labeled ASIL-A, ASIL-B, ASIL-C and ASIL-D.

What is claimed:

1. A method for infrastructure-supported assistance of a motor vehicle using at least two data processing devices, comprising the following steps:
receiving, using the data processing devices, same surroundings data representing a surroundings of the motor vehicle;
respectively calculating, using the data processing devices, infrastructure assistance data for infrastructure-supported assistance of the motor vehicle based on the respective received surroundings data;
comparing, using the data processing devices, the respective self-ascertained infrastructure assistance data with infrastructure assistance data ascertained by another of the at least two data processing devices to respectively calculate a comparison result;
applying, using the data processing devices, a same hash function to the respectively calculated comparison result to calculate a respective hash value;
sending, using the data processing devices, the respectively calculated hash value to the motor vehicle; and
sending, using one of the data processing devices, the infrastructure assistance data ascertained using the one data processing device to the motor vehicle.

2. The method according to claim 1, wherein the data processing devices are each implemented in a separate availability zone.

3. The method according to claim 1, wherein that at least at least three data processing devices are used.

4. The method according to claim 3, wherein two of the data processing devices are implemented in separate availability zones, the wherein at least a third data processing device: (i) is implemented in the availability zone of one of the two data processing devices and is hardware-independent of the one of the two data processing devices, or (ii) is implemented in a separate availability zone.

5. The method according to claim 1, wherein the respective calculation of the infrastructure assistance data is carried out using dissimilar binary code respectively created from the same source code.

6. The method according to claim 1, wherein a respective configuration of the data processing devices is described by one or more configuration parameters, wherein the data processing devices differ from one another in at least one of their configuration parameters.

7. The method according to claim 6, wherein the one or more configuration parameters are respectively selected from the following group of configuration parameters: semiconductor mask set ID of a hardware component of the data processing device, generation of a hardware component of the data processing device, manufacturer of a hardware component of the data processing device, core count of a virtual machine implemented in the data processing device, memory size of a virtual machine implemented in the data processing device, type of a virtual machine implemented in the data processing device, a configuration of an operating system running in the data processing device, type of an operating system running in the data processing device, kernel version of an operating system running in a cloud infrastructure data processing device.

8. A method for at least partially automated guidance of a motor vehicle, the method comprising the following steps:
receiving a respective hash value from at least two data processing devices;
receiving infrastructure assistance data from one of the data processing devices;
determining that the received infrastructure assistance data can be used for at least partially automated guidance of the motor vehicle based on the received hash values.

9. The method according to claim 8, wherein it is determined that the received infrastructure assistance data can be used for at least partially automated guidance of the motor vehicle when the hash values match.

10. The method according to claim 8, wherein said determination is carried out by a watchdog.

11. A system for infrastructure-supported assistance of a motor vehicle, comprising:
at least two data processing devices which are each configured to receive same surroundings data representing a surroundings of the motor vehicle, wherein:
the data processing devices are each configured to respectively calculate infrastructure assistance data for infrastructure-supported assistance of the motor vehicle based on the respective received surroundings data,
the data processing devices are each configured to compare the respective self-ascertained infrastructure assistance data with infrastructure assistance data ascertained by another of the at least two data processing devices to respectively calculate a comparison result,
the data processing devices are each configured to apply a same hash function to the respectively calculated comparison result to calculate a respective hash value,
the data processing devices are each configured to send the respectively calculated hash value to the motor vehicle, and
one of the data processing devices is configured to send the infrastructure assistance data ascertained by the one of the data processing devices to the motor vehicle.

12. An apparatus for at least partially automated guidance of a motor vehicle, comprising:
a communication device configured to receive a respective hash value from at least two data processing devices and infrastructure assistance data from one of the data processing devices; and
a processor device configured to determine that the received infrastructure assistance data can be used for at least partially automated guidance of the motor vehicle based on the received hash values.

13. A non-transitory machine-readable storage medium on which is stored a computer program for at least partially automated guidance of a motor vehicle, the computer program, when executed by a computer, causing the computer to perform the following steps:
receiving a respective hash value from at least two data processing devices;
receiving infrastructure assistance data from one of the data processing devices; and
determining that the received infrastructure assistance data can be used for at least partially automated guidance of the motor vehicle based on the received hash values.
